(19) United States
(12) Patent Application Publication
(10) Pub. No.: US 2015/0371260 A1
(43) Pub. Date: Dec. 24, 2015

(54) SYSTEMS AND METHODS FOR PROVIDING PURCHASE OPTIONS TO CONSUMERS

(71) Applicant: Elwha LLC, Bellevue, WA (US)

(72) Inventors: Alistair K. Chan, Bainbridge Island, WA (US); William D. Duncan, Mill Creek, WA (US); Roderick A. Hyde, Redmond, WA (US); Jordin T. Kare, Seattle, WA (US); Lowell L. Wood, JR., Bellevue, WA (US)

(21) Appl. No.: 14/309,461

(22) Filed: Jun. 19, 2014

(51) Int. Cl. G06Q 30/02; G06T 19/20; G06Q 30/06

(52) U.S. Cl. CPC G06Q 30/0253; G06Q 30/0271; G06Q 30/0643; G06T 19/20; G06T 2219/2024; G06T 2219/2021

(57) ABSTRACT

A purchasing system includes a memory device configured to store image data regarding a user, and a processing circuit coupled to the memory device and configured to generate body data of the user based on the image data. The body data includes a virtual model of the user, with the virtual model providing a depiction of the user. The processing circuit is further configured to generate a customized purchase option for the user based on the body data, and transmit the purchase option to an input/output device.

### BACKGROUND

Imaging systems can obtain still and moving images of a variety of objects or people. Videos and pictures are typically converted into a hard copy (e.g., a photograph) and/or stored digitally as, for example, a JPEG file. With the continual acquisition of such images, the ability to observe, for example, how a person has aged over time, becomes available. Additionally, imaging systems have long been in use in shopping centers to monitor people to prevent, for example, shoplifting.

### SUMMARY

One embodiment relates to a purchasing system having a memory device configured to store image data regarding a user, and a processing circuit coupled to the memory device and configured to generate body data of the user based on the image data. The body data includes a virtual model of the user, the virtual model providing a depiction of the user based on the body data. The processing circuit is further configured to generate a customized purchase option for the user based on the body data, and selectively provide the purchase option to an input/output device based on the body data.

Another embodiment relates to a purchasing system having an image capture device configured to acquire image data of a clothed user and transmit the image data to a processing circuit, a memory device configured to store the image data regarding the user, and a processing circuit coupled to the memory device and the image capture device. The processing circuit is configured to generate body data of the user based on the image data. The body data includes a virtual model of the user. The processing circuit is further configured to generate a customized purchase option for the user based on the body data and selectively provide the purchase option to an input/output device of the user based on the body data.

Still another embodiment relates to a purchasing system having an image capture device configured to acquire image data of a clothed user and transmit the image data to a processing circuit, a memory device configured to store the image data regarding the user, a body image enhancer configured to apply a force to the user to acquire relatively greater detailed image data, and a processing circuit coupled to the memory device, the body image enhancer, and the image capture device. The processing circuit is configured to generate body data of the user based on the image data, generate a customized purchase option for the user based on the body data, selectively provide the purchase option based on the body data, and control the body image enhancer.

Yet another embodiment relates to a computer-implemented method for providing a purchase option including: receiving image data regarding a user at a processing circuit; identifying, by the processing circuit, the user based on at least one of the image data and a user input; generating body data based on the image data using the processing circuit, the body data including a virtual model of the user; and selectively providing, by the processing circuit, a purchase option to the user based on the body data, wherein the purchase option is configured to be applied to the model.

Another embodiment relates to a computer-implemented method for providing a purchase option including: receiving image data regarding a user at a processing circuit; generating body data regarding the user based on the image data using the processing circuit, the body data including a virtual model of the user; and selectively providing, by the processing unit, a customized purchase option based on the body data to the user.

Still another embodiment relates to a shopping system having: a plurality of image capture devices configured to acquire image data regarding a clothed user and transmit the image data to a processing circuit and a processing circuit. The processing circuit is configured to: determine a location of the user; generate body data of the user based on the image data, the body data including a virtual model; and selectively provide a customized purchase option to the user based on the body data and the location of the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an illustration of a purchasing system according to one embodiment.

FIG. 2 is a front view of an image capture device acquiring images of a customer according to one embodiment.

FIG. 3 is a front view of an input/output device used in a purchasing system according to one embodiment.

FIG. 4A is an illustration of a shopping system implementation of the purchasing system of FIG. 1 according to one embodiment.

FIG. 4B is an illustration of another shopping system implementation of the purchasing system of FIG. 1 according to one embodiment.

FIG. 5 is a diagram of a method of receiving a purchase option according to one embodiment.

FIG. 6 is a diagram of a method of providing a purchase option based on acquired data according to one embodiment.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the figures generally, systems and methods for acquiring data regarding a potential customer and providing purchase options to the potential customer are shown according to various embodiments. As used herein, the terms “customer” and “user” are used interchangeably. According to the various embodiments herein, an image capture device obtains image data of a customer. The image data includes either one or both of moving images (i.e., video image) and still photographs of the customer. The image data is analyzed to acquire body data regarding the potential customer, such as their height, gender, shoe size, collar size, ring size, chest sizing, arm length, weight estimate, and an overall body shape and size. With this information, a virtual model of the potential customer can be generated and provided to that customer on, for example, a user input/output device (e.g., a mobile phone). Based on their previous purchases and inputted preferences, various purchase options can be provided to the customer on their user input/output device. Moreover, the purchase options may be selectively provided based on potential inaccuracies in the body data, the inputted preferences, location of the user, identity of the user as determined from the body data, and the like. Furthermore, the depicted model may show how a user would look with a particular purchase option (e.g., a haircut, a specific hair color, a shirt, a blouse, a pair shorts, a pair of shoes, etc.), thereby providing the user with beneficial information to impact their purchasing decision. Because the model is a relatively accurate portrayal of the potential customer, the customer observes how each purchase option would look on/affect him or her. In some embodiments, the generated model is capable of movement such that the customer can also observe how particular items (e.g., a dress) would move with the customer. If the customer wishes to purchase the item or physically try the item on, the customer may receive a location of the item within the store. Or, if the customer is online shopping, the customer may receive a website link for purchasing the item online. As such, purchase options can be customized to each customer, which may enhance their shopping experience while providing the vendor with a potential increase in customer purchases.

According to one embodiment, a customer may be identified using a facial recognition program. After identification, the customer's record may be retrieved. The record may include previous visits to a store, image data and body data of the customer, previous purchases, and/or social network profiles. If a record does not exist, a record may be created and stored for each customer. The record may be utilized to selectively provide customized purchase options to the customer. As an example, suppose a customer walks into a store, and a security camera obtains facial information regarding the customer. The facial information identifies the customer, such that the record pertaining to the customer may be retrieved. The customer's previous purchases, inputted preferences, and/or social network profiles are used to supply customized purchase options to the customer.

According to another embodiment, the system may build a body data model record based on facial recognition and/or body data recognition without an identification being part of the record and anonymously present purchase options to a customer, such as when a customer is in a store. The user may choose to add preferences and other data to the record without adding identification data and allow presentation based only on facial or body data recognition only in certain locations or times (or not at all).

According to various other embodiments, body data generated from the image data can be used for health reasons as well. For example, the body data can include health data such as a body-mass-index, a posture characteristic, a walking gait characteristic, a skin characteristic, etc. The health data can be transmitted to a healthcare provider. The healthcare provider may examine the data, likely over time, to determine if there is anything of concern for that particular user. Early detection of possible health concerns can lead to immediate treatment and prevent minor health risks from becoming major health concerns, thereby avoiding potentially costly medical procedures and improving one's health.

As used herein, the term “customized purchase option” refers to purchase options specific to a particular customer's inputted and/or determined (by, e.g., processing circuit 120) wants, desires, preferences, style, and the like. Accordingly, if the customer has indicated that they like red clothes, clothing related purchase options for that customer will be focused on red clothes. Customized purchase options are also based on the body data of the customer. For example, if the body data indicates that a customer has a size thirty-inch waist, pants purchase options will only include substantially thirty-inch waist pants (an offset may be included, such as thirty-two inch waist and twenty-eight inch waist, to account for size variations between brands). Thus, customized purchase options are specific to the customer, which may increase the likelihood of a sale transaction by that customer.

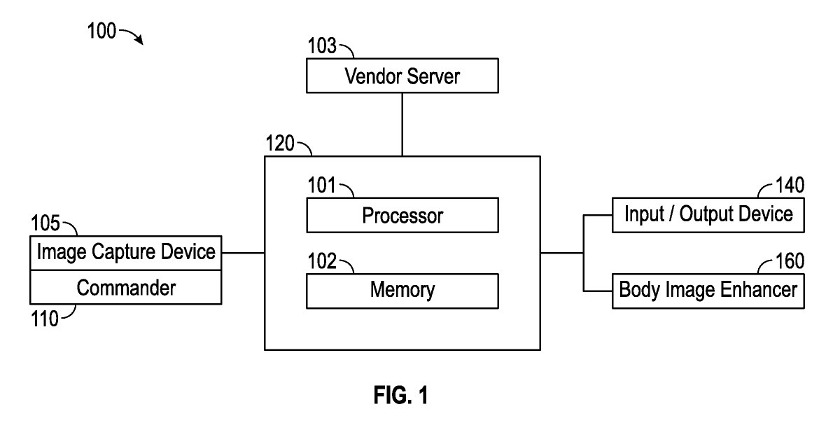

Referring to FIG. 1, purchasing system 100 is shown according to one embodiment. Purchasing system 100 may be implemented within a particular store, a shopping center (e.g., a mall), among a collection of destinations (e.g., stores), and/or over the internet (e.g., multiple vendor websites). Purchasing system 100 is shown to include processing circuit 120, user input/output device 140, and image capture device 105. Processing circuit 120 is shown to include processor 101 and memory 102. In some embodiments, system 100 also includes vendor server 103, commander 110, and body-image enhancer 160.

Referring generally to FIG. 1, image capture device 105 acquires one or more images of a customer (referred to herein as “image data”). The image data (e.g., photographs or video) may be processed by processing circuit 120. Processing circuit 120 processes the image data to generate body data regarding the customer including, in some embodiments, a virtual model of the customer. The generated body data may provide an indication of the shape of the user's body. The body data including the virtual model may be stored in memory 102 of processing circuit 120. Accordingly, changes to the user (e.g., weight gain/loss) may be tracked over time. Furthermore, the virtual model may be transmitted and displayed to the user on input/output device 140. Via device 140, the user may provide an input to confirm accuracy (or inaccuracy) of, and edit their specific body data. Based on the body data and preferences of the user, processing circuit 120 may receive information from one or more vendor servers 103. The information that processing circuit 120 receives from server 103, in connection with the user input information and the generated body data, may be utilized to generate one or more purchase options. The purchase options may be transmitted to device 140 for a user to select or reject the various items suggested (i.e., the purchase options). According to various other embodiments, the purchase options may be generated by vendor server 103 and transmitted to device 140 directly.

Referring to the components of processing circuit 120 separately, processor 101 may be configured as one or more servers that include one or more processors. Typically, processor 101 is configured to perform all or most of the functions of processing circuit 120 as described herein. In some embodiments, the functions of processing circuit 120 (i.e., processor 101) described herein are performed by instructions (e.g., software) on machine-readable media including various hardware components. Processor 101 may be implemented as a general-purpose processor, an application specific integrated circuit (ASIC), one or more field programmable gate arrays (FPGAs), a digital-signal-processor (DSP), a group of processing components, or other suitable electronic processing components. In comparison, memory 102 may be configured as one or more memory devices, which are configured to store the body and image data. According to one embodiment, memory 102 may be one or more electronic devices configured to collect and store data from image capture device 105 and/or processing circuit 120 (e.g., body and image data). Memory 102 may be or include non-transient volatile memory or non-volatile memory. Memory 102 may include database components, object code components, script components, or any other type of information structure for supporting the various activities and information structures described herein. Memory 102 may be communicably connected to processor 101 and provide computer code or instructions to processor 101 for executing the processes described herein. The image and body data may be sent to processing circuit 120 (memory 102 for storage) in real-time (e.g., whenever an image is captured of customer 130, whenever the user adjusts their body data, etc.), periodically (e.g., every fifteen minutes, every hour, etc.), or in response to a request from image capture device 140 and/or processing circuit 120.

According to one embodiment, processing circuit 120 sends instructions to at least one of image capture device 105, commander 110, body-image enhancer 160, vendor server 103, and input/output device 140. For example, processing circuit 120 may direct commander 110 to instruct the user to move into a better location for image capture device 105 to acquire the image data. Alternatively, processing circuit 120 may instruct image capture device 105 to take additional images of the customer, for instance to improve the accuracy of the virtual model. In another embodiment, processing circuit 120 can selectively activate and deactivate body-image enhancer 160 and commander 110.

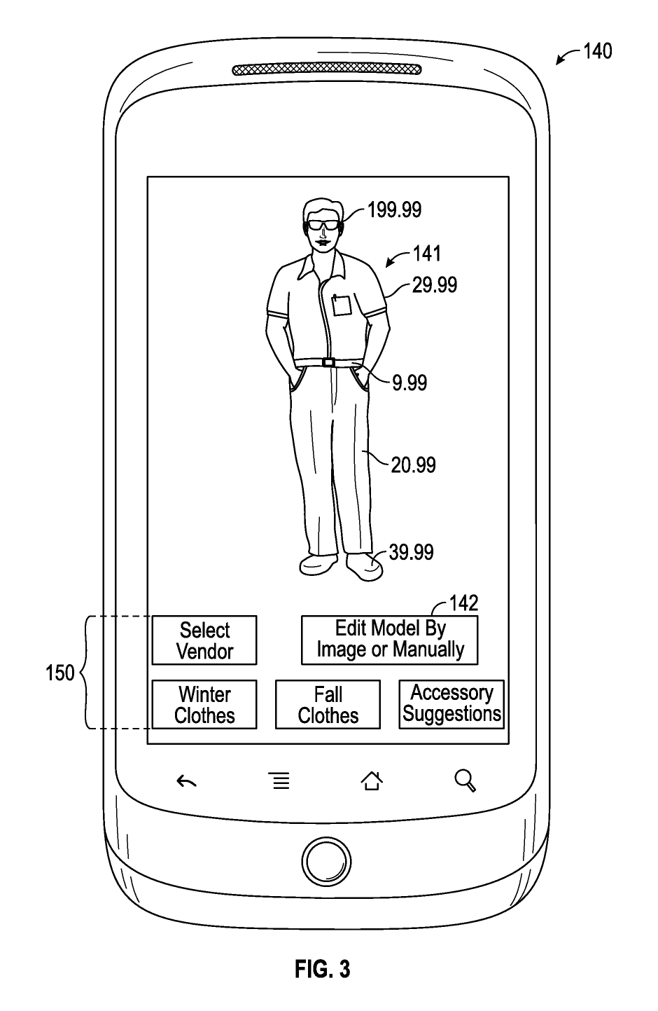

In addition to transmitting instructions, according to one configuration, processing circuit 120 performs a data analysis on the image data. As mentioned above, the image data may include still photograph(s), videos, and any other type of images of the user. In some embodiments, image data regarding a user may be acquired indirectly. For example, the image data may be retrieved from an external database. The external database may include one or more social media profiles of the user. According to one configuration, processing circuit 120 may analyze the image data to generate body data regarding the user. According to one embodiment, the body data includes a virtual three-dimensional model 141 of customer 130 (See FIG. 3), with such model 141 being a relatively accurate depiction (e.g., height, weight, gender, overall body shape, etc.) of customer 130. In some embodiments, model 141 can be generated by assembling a point cloud and creating a mesh based on the pixelated images. One such system for three-dimensional model reconstruction is the ProFORMA: Probabilistic Feature-based On-line Rapid Model Acquisition by Qi Pan et al. Another such system/method is described in Multilinear Pose and Body Shape Estimation of Dressed Subjects from Image Sets by Nils Hasler et al. In addition to model 141 generation, the generated body data may include at least one of biometric data, health/medical related data, safety/protective data, activity data, and/or preference related data (also referred to herein as preference data) of the user. Therefore, processing circuit 120 may selectively provide purchase option 150 based on one or more pieces of biometric data, health/medical data, safety/protective data, activity data, and/or preference data regarding the user.

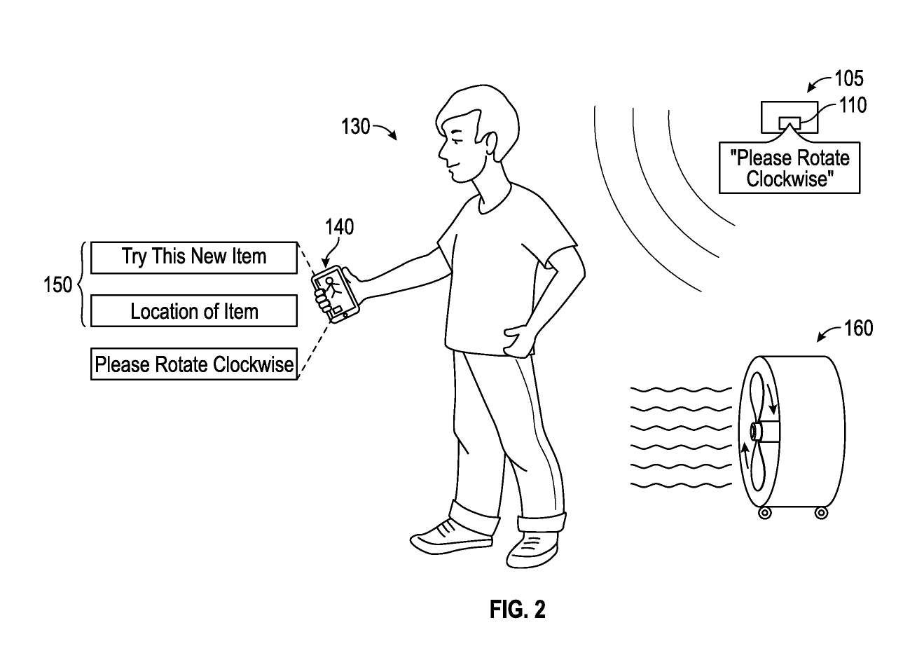

Biometric data may include data relating to the physical features of customer 130 (FIG. 2), such as an indication of their height, weight, gender, body-shape, arm length, leg length, inseam length, hip size, foot size, hand size, neck size, head diameter, collar size, chest size, ring finger size, skin color, eye color, hair length and color, etc. Based on the biometric data, the following types of clothing-related characteristics (used for purchase options 150) may be determined: waist size, hip size, pants length, collar size, shirt size, jacket size, shoe size, belt size, glove size, brassiere size, etc. Accessory-related characteristics may also be determined, such as: sunglass size, ring size, hat size, head-sweatband size, etc. Biometric data may also include data relating to one or more facial features of customer 130 (FIG. 2), such as eye separation, nose shape, lip/mouth shape, eyebrows, ear shape, expression, eye-nose-mouth separations, as well as the afore-mentioned skin color, eye color, hair length and color, etc. These facial features may be used for facial recognition in order to establish (or confirm) an identity of the customer or uniquely process image data. In some applications, facial expressions may be determined to estimate the current mood of the customer, and hence his predicted receptiveness to real-time offerings. In some applications, facial features can be used by processor 101 to predict good (or bad) fashion matches regarding potential offerings of clothes or accessories (e.g., colors, styles, etc.).

Preference related data (e.g., preference data) can include favorite or preferred stores; jewelry type and brand; price range expenditures for particular items; favorite shopping times (e.g., times of the day and/or times of the year); favorite shopping preferences (e.g., online versus in-store); favorite styles of clothing; favorite hair styles and accessory styles; etc. Preference data may also be based on previously acquired body data (e.g., previously acquired clothing data, such as brand X being worn by the user). Preference related data may be determined by processing circuit 120 by tracking a history of purchases by customer 130 to determine, for example, the items and brands repeatedly bought by customer 130. In some embodiments, processing circuit 120 may access or request information from customer 130 regarding one or more of their checking and credit card accounts (e.g., to determine and categorize their purchases to generate preference related data). Processing circuit 120 may also determine preference related data via analysis of the image data. For example, if the image data repeatedly shows the user wearing brand X t-shirts and brand Y jackets, processing circuit 120 may determine that the user prefers brand X t-shirts and brand Y jackets. According to another embodiment, processing circuit 120 may receive preference related data from the user directly (e.g., via input/output device 140). In some embodiments, processing circuit 120 may generate preference related data based on the user's response to purchase option 150. If the user repeatedly rejects brand X purchase option, processing circuit 120 may determine that brand X is not preferred by customer 130, such that purchase options including brand X will not be transmitted to customer 130. As such, any of these techniques may be used separately or together by processing circuit 120 to aid in generating a customized purchase option 150 for customer 130.

The body data may also include activity related data. In addition to being input by the user, the activity related data may also be extracted from the backgrounds of images or the clothing worn in images used to determine body data. Activity data may include an indication of the use of activity equipment for a user, such as at least one of a size of a bicycle frame, a racquet, a golf club, a ski suit, a ski and a snowboard. For example, image data may be acquired of the user snowboarding, such that the details of the user's snowboard may be determined by processing circuit 120 (e.g., brand, year, and model of the snowboard). Processing circuit 120 may then provide a purchase option based on this determination (e.g., “Would you like a current brand X snowboard to replace your two year old brand X snowboard?”). The extracted activity data may also allow the activities that the user likes to engage in, such as skiing and horseback riding to be determined, their priority, and the likely state of wear of the equipment associated with the activity from their frequency. Suggestions for activity related purchases, such as sporting goods and their sizes, may be made to the user based on these determinations.

Clothing and activity related preferences extracted from images, social media and other data supplied by the user may be ignored in order to present a “make over” set of purchase options, consistent with the user's body data and activities and events, which depart from the user's usual look, brands or price points.

Safety/protective data may include an indication of the use of safety equipment for a user. This may include an indication of a size and type of: safety helmet, knee pad, elbow pad, safety harness, protective apron, safety glove, life jacket, and overalls.

According to an alternate embodiment, the body data may be used in connection with acquiring and tracking health/medical related data. For example, based on the body data, an indication of a body-mass-index estimation, a posture characteristic, and skin related issues (e.g., the presence of a new mole could indicate an onset of melanoma or an allergic reaction to a new cosmetic) may be determined by processing circuit 120. The health/medical data may include an indication of medical support and orthopedic devices. This may include at least one of a size of a crutch, a knee brace, a foot brace, a wrist brace, a support hosiery, a wheel chair and a neck brace. In some embodiments, the image data may be captured over time and sent to the health provider/hospital/doctor of the user to be added to their medical history. Accordingly, the image data may be examined remotely by the healthcare provider of the user, thereby saving the user time from having to physically visit the doctor's office.

The body data (e.g., preference data, health/medical data, safety/protective data, activity data, biometric data, etc.) may be extracted from social media, social media timelines, calendars, and events in addition to and/or in place of being generated from the image data. For instance, purchase options may be offered in respect of a forthcoming holiday, job interview, party or wedding, using the user's body data and, for example, the user's peer or social group, and career aspirations. Preference data, in respect of career or occupation, may be extracted from images, social media, calendars and user entered data. The system may present custom purchase options for work related events such as a sales meeting or the sizes and type of safety equipment associated with the user's occupation.

According to another embodiment, processing circuit 120 may perform additional data analysis regarding tracking/storing the body and image data. For example, processing circuit 120 may determine averages, trends, metrics, etc., for one or more users, such as how much weight (or other data characteristic) a user has gained/lost over a specific time frame. Processing circuit 120 may customize purchase options 150 based on these metrics. In another embodiment, processing circuit 120 can track the preference related data of the user. For example, if a user continuously wears brand X clothes, this preference can be tracked by memory 102 and utilized to generate one or more purchase options by processing circuit 120. As another example, if a customer shops exclusively at store A for dress shirts and exclusively at store B for dress pants, then one or more purchase options 150 (see FIG. 3) may include dress pants from store B and a dress shirt from store A. Not only can the dress shirt and pants be in the customer's appropriate size, but based on other purchases, the color and fit suggested can be tailored to those purchases (i.e., the purchase options provided are customized to the user). In this example, if the customer just purchased a new pair of mahogany dress shoes, the pants and shirts suggested from stores A and B, respectively, may be suggested to match the customer's new shoes. However, this type of style purchase option does not need to be limited to clothing-related preferences. For example, based on the customer's history of purchasing long necklaces (e.g., to their navel), processing circuit 120 may provide purchase option 150 (see FIG. 2) that includes a necklace that matches the customer's recent clothing purchases with lengths to the customer's navel. Furthermore, processing circuit 120 may also provide purchase option 150 that includes hair colors and styles to accentuate/achieve a specific style for the customer. These purchase options may be applied to model 141 for the customer to observe how he/she would look if they accepted purchase option 150. As yet another example, the processing circuit 120 may determine, based on shape change, that the user is pregnant or post-partum and offer clothing-related purchase options related to pregnancy such as pants, and dresses, brassieres, or nursing brassieres. This determination may be based on a threshold percent deviation in size of a body part of the user within a certain time frame. For example, over the past nine months, the user's midsection/belly has appeared to grow by forty-percent while the sizes of other parts of their body have stayed substantially constant. Based on this percent growth and its location (and gender of the user), the processing circuit 120 may determine that the user is pregnant and provide custom suggestions based on that determination. In this event, the purchase options provided to the user may expand from being specific to the user to include purchase options that may be useful for expectant mothers/fathers (e.g., baby crib, baby clothes, baby bottles, etc.).

Referring further to FIG. 1, according to one embodiment, processing circuit 120 obtains information from vendor server 103 to generate the one or more purchase options. For example, if the customer has entered a preference that he/she does not like black clothing, processing circuit 120 will filter data received from vendor server 103 to remove black clothing. Vendor server 103 may include one or more data storage devices in communication with one or more processors. Vendor server 103 may include one or more vendor databases (e.g., Brand X clothing catalog), portals to internet search engines, and one or more location-specific databases. A location-specific database may include a database specific to a particular location. For example, if a user is within a specific store, Store A, Store A may have its own database (corresponding to its own specific inventory) that provides the information for purchase options 150 (FIG. 3). In an alternate embodiment, where the store is a part of a chain of stores, there may be one central database that provides purchase options to customers based on the store they are currently visiting. In another embodiment, if the user is not within a shopping location or store, the purchase option may include a link to a particular vendor's database. For example, if the customer is online shopping from their home, a received purchase option may include a link to the particular item suggested (e.g., a specific color and size dress shirt sold by Store A). Accordingly, in one embodiment, vendor server 103 may be responsible for providing information to processing circuit 120. Processing circuit 120 processes the information in regard to the body data relating to customer 130 and generates one or more purchase options 150 for that customer. According to an alternate embodiment, vendor server 103 can communicate directly with the user via input/output device 140 to provide, for example, one or more purchase options.

Referring next to FIGS. 2-3 in connection with FIG. 1, image capture device 105, commander 110, body-image enhancer 160, and input/output device 140 are further illustrated according to one embodiment. Image capture device 105 acquires images (i.e., image data) regarding customer 130. As mentioned above, the image data can include video images and/or still photographs. According to one embodiment, image capture device 105 includes a camera. The camera may acquire several images of customer 130 via multiple-burst camera shots. The image capture device 105 may also be a three-dimensional imager. Image capture device 105 may also include a video-camera, such that moving images (e.g., video) can be acquired of customer 130. According to another embodiment, more than one image capture device 105 may be used to acquire image data regarding customer 130. As such, the images may be acquired at various times and places (e.g., a first image acquired in March 2012 at Store A and a second image acquired in November 2013 at Store B). According to various other embodiments, image capture device 105 may include pre-existing image capture devices (e.g., security cameras already in various locations). Image capture device 105 may also include zoom-in and zoom-out features. As such, the image data may include zoomed-in information, such as a finger of customer 130 for acquiring, for example, their ring size information. According to various other embodiments, image capture device 105 may include a full-body scanner. The full-body scanner can include active and passive millimeter-wave scanners, backscattering x-ray scanners, laser scanners, etc.

To allow for efficient processing and acquisition of body data, image capture device 105 may acquire the image data while customer 130 is fully or partially clothed. For example, depending on where customer 130 lives, customer 130 may wear a thicker, thinner, or no jacket at all depending on the season (e.g., winter). Nonetheless, image capture device 105 acquires the moving and/or still images of customer 130 with customer 130 not having to remove any clothing. Although customer 130 is clothed, processing circuit 120 can generate body data and a virtual model of customer 130 using one of the methods described above (e.g., ProFORMA: Probabilistic Feature-based On-line Rapid Model Acquisition by Qi Pan et al.). As such, customer 130 does not have to remove clothes or visit a tailor to obtain precise body measurements. Capturing images of clothed customer 130 may streamline the shopping experience by, for example, eliminating time-consuming activities, such as trying to find one's size with a salesperson.

To address deficiencies or inaccuracies resulting from incomplete images, image capture device 105 may include commander 110. Commander 110 delivers instructions to customer 130 in order to obtain a detailed full body image of customer 130. For example, processing circuit 120 may direct commander 110 to instruct customer 130 to move left or right, to rotate, and/or to turn one or more of their extremities. In one embodiment, processing circuit 120 directs commander 110 to send these instructions electronically (e.g., email, text message, push notification, etc.) via a network to input/output device 140 of customer 130. According to alternate embodiments, processing circuit 120 directs commander 110 to transmit audio and/or visual messages to customer 130. For example, image capture device 105 may include a screen that displays messages (e.g., “please turn to your right”) and/or include speakers that provide audible instructions. Moreover, if customer 130 has moved out of range or sight of image capture device 105, commander 110 may provide instructions to customer 130 to return to the image-capturing area via, for example, a text message. Thus, at the direction of processing circuit 120, commander 110 may transmit visual instructions, audio instructions, and/or electronic instructions to customer 130 to aid in the aid acquisition of image data.

Referring still to FIG. 2, body-image enhancer 160 is shown according to one embodiment. According to one embodiment, processing circuit 120 controls body-image enhancer 160. Whereas commander 110 instructs customer 130 into various positions for image capture device 105, body-image enhancer 160 provides a physical force to customer 130 to accentuate the body of customer 130 to obtain detailed imaged data. Typically, because image capture device 105 acquires image data of customer 130 while clothed, depending on the season or what customer 130 is wearing, some measurements may require more accuracy than what may be provided while that portion of customer 130 is fully clothed. For example, ring size measurements may be difficult to obtain if it is winter and the customer is wearing gloves. Accordingly, body-image enhancer 160 may apply a force to the customer's glove and finger in order to obtain a precise ring-finger size while the customer is wearing the gloves. Thus, body-image enhancer 160 provides a force to the clothing of customer 130 to better detail the body shape (including shape and size of other features of the body, for example, neck size and arm length) of that customer. Body-image enhancer 160 includes, but is not limited to, an air mover (e.g., a fan), a sucker/puller (e.g., a vacuum-like machine that pulls clothes tight against one's body), and a presser configured to press the clothes of a user close to the body of the user.

Referring to FIG. 3, virtual model 141 of customer 130 on input/output device 140 is shown according to one embodiment. Input/output device 140 can include a mobile phone, a desktop computer, a laptop computer, a tablet computer, a personal digital assistant (“PDA”), a watch, etc. According to one embodiment, input/output device 140 is provided with representative model 141 of customer 130 from processing circuit 120. According to an alternate embodiment, processing circuit 120 does not transmit model 141 to input/output device 140, but does transmit one or more purchase options 150. In the configuration where customer 130 receives model 141, customer 130 can view a virtual model 141 of himself or herself. Customer 130 can also alter model 141, if desired. According to one embodiment, model 141 includes motion capabilities, such that the user can observe how, for example, a suggested pair of pants would look while the user is walking, jumping, running etc. According to another embodiment, because model 141 is generated from body data regarding customer 130, model 141 depicts a relatively accurate picture of customer 130 (i.e., height, weight, body shape, etc.). As such, customer 130 may accurately observe how purchase options 150 would affect him/her. In some embodiments, processing circuit 120 is configured to transmit a user selected visual representation of the virtual model.

Referring further to FIG. 3, input/output device 140 permits customer 130 to input information. The information can include a validation (i.e., accuracy confirmation and/or inaccuracy input) of and/or an adjustment to all or some of the aspects of the body data (e.g., the biometric data, preference related data, safety/protective data, activity data, and/or health related data) including model 141; a system control feature; a preference; a user preferred view; and/or a purchase option response. As mentioned above, processing circuit 110 may receive validation in the form of confirmation that aspects of the body and/or image data regarding the customer is accurate (or, inaccurate). For example, a user may indicate that their pants length biometric data is correct but their arm length biometric data is incorrect. Accordingly, various aspects of the biometric data, safety/protective data, activity data, preference data, and/or health related data may be confirmed accurate or inaccurate. In turn, in some embodiments, processing circuit 120 may only provide purchase options for accurate aspects of the body data. In regard to editing/adjusting body data including model 141, in the example shown in FIG. 3, model adjustment button 142 allows customer 130 to either manually adjust their body data and/or upload additional image data. Accordingly, if the user chooses to input an adjustment to their model manually, the user may input a height less than that depicted in the model; a waist size more than that depicted in the model; a ring size larger than in the model; etc. In comparison, if a user chooses to input an adjustment to their model “by image,” then the user may upload additional image data of himself/herself to processing circuit 120 for processing. According to one embodiment, processing circuit 120 acquires additional image data from a user's social media website or other sources to augment the already-acquired image data to generate more accurate body data including model 141. As such, after acquisition of the additional image data or manual inputs, processing circuit 120 may update/alter model 141 and provide the updated model to customer 130 (e.g., via his/her input/output device 140). The user may also choose to represent themselves in body data images, whilst still preserving accurate body data, as being less heavy or slightly taller than reality or more muscular. In addition, the user may wish the system to provide before and after body data, corresponding to changes from an exercise program, diet program, physiotherapy, cosmetic surgery and the like and store these as alternate body data. Accordingly, body data that represents a user's biometric data may be altered by processing circuit 120 based on manual inputs and/or additional image data inputs.

As mentioned above, the input may also include a user preferred view. The user preferred view includes at least one of an accurate and an inaccurate graphical representation of the user virtual model. The user preferred view may also include allowing the system (e.g., processing circuit 120) to suggest body models based on the effect of cosmetic surgery and procedures. The effect could be based on procedures including, but not limited to, rhinoplasty, facial procedures, breast reduction or augmentation, and liposuction.

In some embodiments, the user may also input body data regarding the user's preferences. The preferences of the user may include, but are not limited to: clothing brands, styles, fits, colors, materials, price ranges, etc.; hair colors and styles; hat styles, brands, logos, prices, fits (e.g., adjustable size versus fitted), etc.; belt brands, colors, lengths, styles, price ranges, etc.; sunglass brands, styles, colors, tints, etc.; ring brand and styles; shoe colors, brands, sizes, etc.; etc. In other embodiments, from a history of captured image data, the preferences may be determined by processing circuit 120. For example, if eighty-percent of captured images of the user wearing dress pants depict the user wearing Store A brand dress pants, then dress pants purchase options may be primarily Store A brand. Thus, purchase options 150 may be customized to the preferences of customer 130.

The user may also input a purchase option response via input/output device 140, which is received and processed by processing circuit 120. The purchase option response may include rejecting purchase option 150, applying purchase option 150 to model 141, requesting to locate purchase option 150, requesting an alternate purchase option, a response to provide model 141 to a website (e.g., the user may allow processing circuit 120 to provide the model to a vendor's website), and/or purchasing purchase option 150. For example, assume purchase option 150 includes a pair of black Store A dress pants. If the user likes the suggested pants (due to, e.g., color or price), the user may apply that particular pair of dress pants to their model 141. Accordingly, if customer 130 is online shopping without the ability to try on the pants, the user may apply the suggested item to model 141 to depict how the user would look in the suggested dress pants. If customer 130 is in the store (i.e., Store A), not only can model 141 show how the user would look in the pants, but a further purchase option 150 may include a request to locate the pants within Store A for physically trying them on. In regard to the request to locate a displayed purchase option, processing circuit 120 can either direct the user to the item within the location (e.g., pants within Store A) and/or provide an internet portal for the user to locate the item online. The user may want to share the purchase option 150 applied to the model 141 with friends to help determine their desire to purchase. The images shared may be based on an accurate model of the body data and clothing or a user determined more flattering look such as appearing a little taller or slimmer. Lastly, the user may provide an input indicating the user wishes to purchase the purchase option 150. For example, if the user is online shopping, after applying the purchase option to their model 141 (or without applying the purchase option to model 141), the user may like the way the suggested pants look, and choose to purchase the pants. In regard to a health related purchase option (e.g., to exercise more), the purchase option response may include an “acceptance.” As such, in one embodiment, the accepted purchase option is added as a calendar item or an item on a to-do list for the user. Accordingly, processing circuit 120 may update model 141, locate purchase option 150, and/or allow for purchase of purchase option 150 based on the purchase option response by the user.

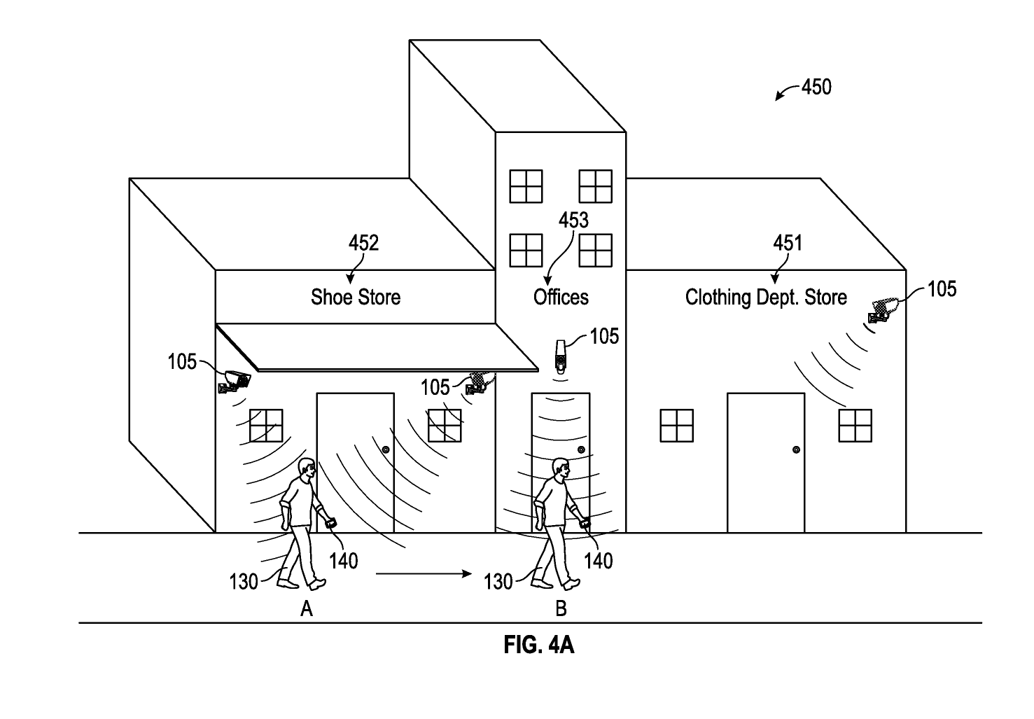

The input may also include a system control feature. In some embodiments, the system control feature may include three application modes and system 100 may be configured to operate according to a selected mode based on the received input. In a first mode, system 100 neither acquires image data nor provides purchase options 150 to customer 130 (on input/output device 140). In a second mode, system 100 acquires image data but does not provide purchase options 150 to customer 130. In this embodiment, the image data may be acquired anonymously for data collection purposes by, for example, store 500 (FIG. 4B). Store 500 may use the images to acquire general trends of people shopping at the store: age, height, weight, gender, etc. In one embodiment, store 500 may offer discounts or coupons for customers who choose to participate by allowing their images to be acquired anonymously. In a third mode, system 100 acquires image data and provides purchase options 150 to customer 130. According to one embodiment, a user can control operation of the modes via input/output device 140. According to other embodiments, customer 130 may selectively activate and deactivate implementation of system 100 at any time via input/output device 140. Moreover, a user may control the frequency with which purchase options may be provided to his/her input/output device 140.

Referring further to FIG. 3, after the image data is processed, one or more purchase options 150 may be provided by processing circuit 120 to input/output device 140. Although only a few types of purchase options 150 are shown in FIGS. 2 and 3, countless types and variations of purchase options 150 are possible. One or more purchase options 150 may include, but are not limited to, the following: clothing related purchase options; fashion/style related purchase options; and/or location purchase options. Clothing related purchase options may include type, brand, size, price range, and colors of: pants, shirts, shorts, jackets, undergarments, shoes, belts, and hats. Fashion/style purchase options may include at least one of a hair style, a hair color, a hair length, a fingernail style and color, a make-up color, a piece of jewelry, or other options that may include purchase of a service such as hair, styling, etc. Fashion/style purchase options may also include a type (e.g., only organic), brand, and price of hair products (e.g., shampoo, gel, conditioner, mousse, curlers, etc.), jewelry (e.g., earrings, watches, necklaces, etc.), nail products (e.g., nail paint, lacquer, finish, etc.), etc. Location purchase options may include where the user can purchase the suggested item (e.g., online only or in the store, the store that carries the item, etc.), where the item is physically located (e.g., within the store that they are in, or somewhere nearby), and/or provide the user with a link to an online store for purchasing the item over the Internet.

In one embodiment, processing circuit 120 provides purchase options 150 based on a determined identity of a user. Processing circuit 120 may utilize a facial recognition program identifies the user. For example, processing circuit 120 may compare acquired images of users to one or more images stored in memory device 102. In another embodiment, processing circuit 120 may determine a user's identity based on the user's virtual model (e.g., compare the generated virtual model to virtual models stored in memory device 102 or with a server, such as online storage). In certain other embodiments, processing circuit 120 uses the biometric data to determine an identity of the user (e.g., compares the biometric data generated to stored biometric data to determine if there is a match). The comparison process(es) used by processing circuit 120 may also be preset by a user. Based on the identity of the user, processing circuit 120 may retrieve his/her record in order to generate and provide customized purchase options.

Due to the possibility of insufficient image data, the generated body data and/or virtual model may be inaccurate. As mentioned above, in one embodiment, processing circuit 120 may determine that all or some aspects of the body data and/or virtual model is inaccurate based on predefined standards stored in memory 102, the record of the customer, comparison to additional body data and/or existing body data, various matching processes, and/or inputs received from customer 130. Predefined standards may include waist-to-chest relationships, leg length-to-total height relationships, and the like. For example, a preset waist-to-chest relationship may be ninety percent to one-hundred and ten percent. If processing circuit 120 determines a waist-to-chest width relationship outside of that acceptable range, processing circuit 120 may determine that waist and chest body data is inaccurate and therefore only provide purchase options not pertaining to the customer's waist and chest. A customer's record may also be utilized to determine accuracy of the body data. As mentioned above, the record of the customer may include previous visits to a store, image data and body data of the customer, previous purchases, and/or social network profiles. As also mentioned above, processing circuit 120 may determine averages, trends, metrics, and the like regarding the body data. Accordingly, predetermined acceptable deviations from the determined metrics may be utilized to determine accuracy. For example, processing circuit 120 may utilize a moving average that determines that a customer has been increasing about an inch in their waist size every year. If the body data indicates a three inch waist size increase from the past year, processing circuit 120 may determine a potential inaccuracy in the waist size body data. Accordingly, processing circuit 120 may provide purchase options based on the previous waist size or determine that no waist-size related purchase options should be provided at this time. In another embodiment, processing circuit 120 may request additional image data to generate additional body data to determine the accuracy of previously generated body data. For example, processing circuit 120 may determine that a customer has increased in waist size by five inches based on the recently acquired image data. Processing circuit 120 may acquire additional image data to generate additional waist-related body data to determine if the additional waist-related body data also indicates a five inch waist gain. If not, processing circuit 120 may determine a potential inaccuracy in the waist-related body data. Processing circuit 120 may also utilize various matching processes, such as formulas, algorithms, and the like that compare recently generated body data to the body data of record of the customer. Finally, processing circuit 120 may receive an accuracy or inaccuracy input from the customer regarding all or some of the body data. For example, the customer may input via device 140 that the waist-related body data is accurate but the pants length data is inaccurate. Processing unit 120 may use its accuracy assessments so as to preferentially offer purchase options pertaining to body regions where the customer's body data or the corresponding virtual model is most accurate. This preferential treatment may comprise offering purchase options only where accuracy is above a specified threshold, and not offering such options where accuracy is below a specified threshold. In some embodiments, the number or type of options offered may be dependent on the accuracy of the body data or model or the location of the user, such as non-store locations where try-on of options is not available.

If processing circuit 120 determines that one or more pieces of body data appear inaccurate, processing circuit 120 may request additional images from the customer on device 140, may wait for image capture device 105 to acquire additional image data regarding potentially inaccurate body data, and/or access the customer's social media website or other profile to acquire additional image data. Processing circuit 120 may re-determine the accuracy of the body data based on the additional images. Processing circuit 120 may also predict the ability of one or more additional images to improve the accuracy of a particular type of body data, and may therefore request or command corresponding images to be taken or obtained. For instance, given the customer's posture, an image from his left side may accurately determine his waist size, but one from his right side will not. Processing circuit 120 may selectively deactivate transmission of purchase options that pertain to the potentially inaccurate aspects of the body data. For example, a customer may indicate that the body data is inaccurate regarding his/her waist size. If the customer does not input the correct waist size, processing circuit 120 may determine that waist-related purchase options (i.e., no pants, shorts, dress, etc.) should not be provided. Accordingly, processing circuit 120 may provide purchase options regarding only accurate body data.

Processing circuit 120 may also determine the accuracy of preference related data before providing a preference related purchase option as well. Processing circuit 120 may determine accuracy of the preference related data in similar manners as that for body data (e.g., predefined standards stored in memory 102, the record of the customer, comparison to additional and/or existing preference related data, various matching processes, and/or inputs received from customer 130). As such, in one embodiment, processing circuit 120 may retrieve the record of the customer (e.g., social network profiles, purchasing history, inputted preferences, etc.) to determine accuracy. In another embodiment, processing circuit 120 may request validation of preference related data via device 140. If not validated, processing circuit 120 may selectively refrain from providing preference related purchase options pertinent to the potentially inaccurate preference data. For example, memory 102 may have a folder of a customer with primarily image data of the customer in a suit. If subsequent image data is gathered around Halloween with the customer dressed in a costume, processing circuit 120 may not provide fashion/style purchase options relevant to the costume due to the likely inaccuracy. Accordingly, in some embodiments, preference related data may need to be validated (accuracy confirmed) prior to processing circuit 120 providing purchasing options regarding some or all of the preference related data.

In certain embodiments, processing circuit 120 may provide purchase options in response to an inputted preference. For example, the user's history (previous purchases, social media profiles, etc.) may indicate a “preppy style” (e.g., collared shirts, khaki pants, etc.). However the user has since become interested in skateboards, bicycle motocross (“BMX”), and rollerblading and desires a style to match his/her new interest. Accordingly, the user enters a different style preference than “preppy,” which is received by processing circuit 120. Processing circuit 120 may provide fashion/style purchase options regarding this inputted style, whereby the user may observe how he or she would look on virtual model 141 if he or she chose to pursue the style in real life.

In some embodiments, processing circuit 120 may provide purchase options that help match the user's preference with an observed preference related data aspect (e.g., style). For example, a user may select image data of the user's friends, colleagues, other persons, advertisements, and the like. The image data may be obtained from social network platforms, vendor websites, images taken by the user and uploaded to processing circuit 120, and various other types of image data transmissions to processing circuit 120. The user may input that he/she wants to have a style like that shown in the advertisement or that of a friend. For example, the user may input image data of a friend that has a “preppy style.” Processing circuit 120 may retrieve purchase options from, e.g., vendor server 103, and/or image data of others who appear to have a “preppy style” for confirmation by the user. The user may accept or reject the provided styles via device 140. Upon acceptance, processing circuit 120 may provide purchase options that match the confirmed style. As an example, suppose the user selects a picture of a model wearing Brand X clothes from a specific line (e.g., fall fashion line) of Brand X. Processing circuit 120 may retrieve additional Brand X clothes from that line and provide them as purchase options to the user. In some embodiments, the user may have attempted to achieve the, for example, “preppy style” on their own. Accordingly, processing circuit 120 may provide purchase options that fix or aid the user in matching the observed “preppy style.” For example, the image data observed by the user may show a model wearing Brand X shoes, Brand Y pants, and a Brand Z coat. If the image data of the user shows him/her wearing Brand A shoes, Brand Y pants, and a Brand B coat. Processing circuit 120 may provide Brand X shoes and a Brand Z coat purchase option to help the user better match their desired style (i.e., preference related data aspect). In another example, suppose the user has an upcoming job interview. The user may input image data of people wearing job interview attire (e.g., a suit and a tie). In another embodiment, the user may input a preference of “formal business attire.” Based on the image data and/or the inputted preference, processing circuit 120 may provide purchase options of formal clothes for a job interview for the user. Processing circuit 120 may utilize the body data to provide the clothes in size specific to the user and may provide model 141 of the user with the clothes.

In some other embodiments, processing circuit 120 may provide purchase options related to a group that the user may want to join. For example, the user may input a preference of joining a band. Processing circuit 120 may provide purchase options based on the preferred band type. For example, style purchase options provided by processing circuit 120 may differ if the band was a rock genre or a classical music genre band. Accordingly, processing circuit 120 provides purchase options to aid the user in achieving their desired style, with the desired being inputted by the user and/or suggested by processing circuit 120.

According to an alternate embodiment, the one or more purchase options 150 may be related to the health of the user. For example, the purchase option may be: “based on your recent weight gain, you may want to see a doctor to make sure that your cardiovascular system is functioning correctly,” or, “our records indicate that you have not been to the doctor in five years, would you like to schedule an appointment?” Accordingly, health-related purchase options 150 may include, but are not limited to, scheduling a doctor, chiropractor, dermatologist, physiotherapist, dietician, dentist, eye-doctor, etc. appointment; and exercise reminders. As such, a location purchase option based on the health of the user may include a website link to the user's healthcare provider to schedule an appointment.

Although many different implementations of system 100 are possible, FIGS. 4A-4B show examples of shopping system implementations of purchasing system 100. Referring to FIG. 4A, a shopping environment implementation of system 100 is shown according to one embodiment. In this embodiment, the shopping environment is not limited to just a particular location, like shown in FIG. 4B. Accordingly, in FIG. 4B, the shopping system 450 can include a mall or shopping locations dispersed anywhere, but connected to processing circuit 120 (via, e.g., the Internet). Furthermore, in both FIGS. 4A-4B, a plurality of image capture devices 105 may be employed to acquire image data regarding one or more users. Accordingly, the user's location can be determined based on which image capture device acquires image data of the user, an input from the user, a global positioning system (or other location determining system) within input/output device 140 of user, etc. As such, processing circuit 120 may provide purchase options 150 based on the location of the user.

Referring more particularly to FIG. 4A, image capture device 105 acquires image data of customer 130 at a first point A, and a second point B. In operation, there may be additional points. Based on image data acquired by image capture devices 105 at the first point and image data acquired by image capture devices at or near the second point, the processing circuit 120 may determine approximately where customer 130 is located and the direction they are heading (e.g., Clothing Dept. Store 451). Moreover, by placing image capture devices 105 in strategic locations (as shown), numerous different angled images may be acquired, such that a higher possibility exists that an accurate model 141 may be generated by processing circuit 120. If customer 130 is heading toward Clothing Dept. Store 451 image capture devices 105 of Shoe Store 452 and Office Building 453 may have captured several images prior to customer 130 reaching Clothing Dept. Store 451. As such, upon arrival, processing circuit 120 may provide purchase options to the user's input/output device 140 almost immediately upon entering the store. Thus, in this configuration, the various locations and image capture devices 105 work collectively to acquire image data of customer 130, which is used by processing circuit 120 to determine where customer 130 is located and what purchase options 150 to provide to customer 130.

Although the locations may work collectively, according to one embodiment, a location-specific vendor server 103 may be implemented in FIG. 4A. As such, upon customer 130 entering Clothing Dept. Store 451 processing circuit 120 transmits purchase options 150 that pertain to that store to customer 130. For example, if the store sells only hats, only hat-related purchase options for the particular store will be provided to customer 130 by processing circuit 120. If customer 130 leaves the store and enters Shoe Store 452, only shoe-related purchase options will be provided to customer 130 by processing circuit 120. However, customer 130 can, via input/output device 140, enter preferences that allow purchase options to come from vendors outside of their present location. For example, if customer 130 desires style purchase options while in Shoe Store 452, processing circuit 120 may provide information pertaining to accessories or clothes that match the style shoes that customer 130 is presently examining. Moreover, because customer 130 cannot physically try on the suggested clothes while at Shoe Store 452, processing circuit 120 can edit model 141 to show how the suggested clothes would look with a chosen pair of shoes via user input (i.e., “accept and apply suggested clothes to model 141”). Thus, model 141 can be dynamically updated in regard to the preferences and accepted purchase options 150 by customer 130.

In some embodiments, the image and body data for a plurality of customers may be stored by processing circuit 120. In this embodiment, processing circuit 120 may be structured as one or more servers. Vendors desiring to provide purchase options regarding their products or services to customers may be required to purchase the data. Once purchased, the vendors may provide the purchase options. In this embodiment, the image and body data may be used with a wide variety of products and services. For example, the resultant body data may be purchased by airlines to determine average sizes for manufacturing airliner seats. In this example, the image data (and resultant body data) may be based on only the data acquired in airports, so to limit it to people who travel versus the population as whole. In an alternate embodiment, users may be required to purchase a subscription to receive purchase options. Thus, implementation of system 100 may restrict non-paying vendors (in the alternative, users) from use of providing (receiving) purchase options.

Referring next to FIG. 4B, another shopping environment implementation of system 100 is shown according to one embodiment. FIG. 4B represents an isolated implementation of system 100 (e.g., within store 400). As such, FIG. 4B depicts an example where system 100 is implemented within a single location. The location may include a diverse collection of items. For example, store 400 could include Macy's, Sears, Wal-Mart, K-Mart, etc.

Referring more particularly to FIG. 4B, according to one embodiment, store 400 includes entranceway 410. As customer 130 enters entranceway 410, one or more image capture devices 105 acquire one or more images of customer 130. According to one embodiment, image capture device 105 includes commander 110 that directs customer 130 into a proper orientation for acquisition of the image data. According to one embodiment, the image data are transmitted to processing circuit 120 for processing. Processing circuit 120 generates body data relating to customer 130 based on the image data. As mentioned above, the body data may include a virtual model of customer 130 as well as biometric data, preference related data, and/or health related data. According to one embodiment, the body data may be used to determine the identity of customer 130. For instance, the body data may comprise facial images of the customer, enabling identification via facial recognition. Alternatively, the identification may comprise matching parameters of a virtual model of the customer to those in a data base of virtual models. In some embodiments, the identification may comprise matching biometric data of the customer to those in a data base of biometric data. The identification may also be based on a comparison of a generated virtual model of a user to a previously generated virtual model. The identifications may be “local”, i.e., identifying the customer from a set of customers previously encountered in the store, or they may be “global”, identifying the customer (who may never have been previously encountered within the store) against a larger set of people (e.g., based on a mall, a chain of stores, a city, a nation, etc.). In some embodiments, the customer identification may include details such as name, address, social security number, credit status, etc. In other embodiments, the identification may only be used to link to records such as preference data, biometric data, purchase history, or the like.

In the example in FIG. 4B, as customer 130 moves from point 401 to point 402 to point 403, processing circuit 120 provides different purchase options to input/output device 140 of customer 130 based on their location. As mentioned above, their location may be determined based on which image capture device 105 is acquiring image data, a user input, etc. As an example, when customer is at location 402, processing circuit 120 pushes purchase options relating to shoes to input/output device 140. The shoe-related purchase options may include styles, colors, and even locations of where to find specific shoes. According to one embodiment, customer 130 may accept or reject the purchase options 150 (e.g., via a purchase option response). If customer 130 requests the purchase option, processing circuit 120 can notify store 400 employees to obtain that item for customer 130 to try on when they reach 403 (“changing rooms”). According to an alternate embodiment, processing circuit 120 transmits a notification to customer 130 of the item location for them to personally obtain it.

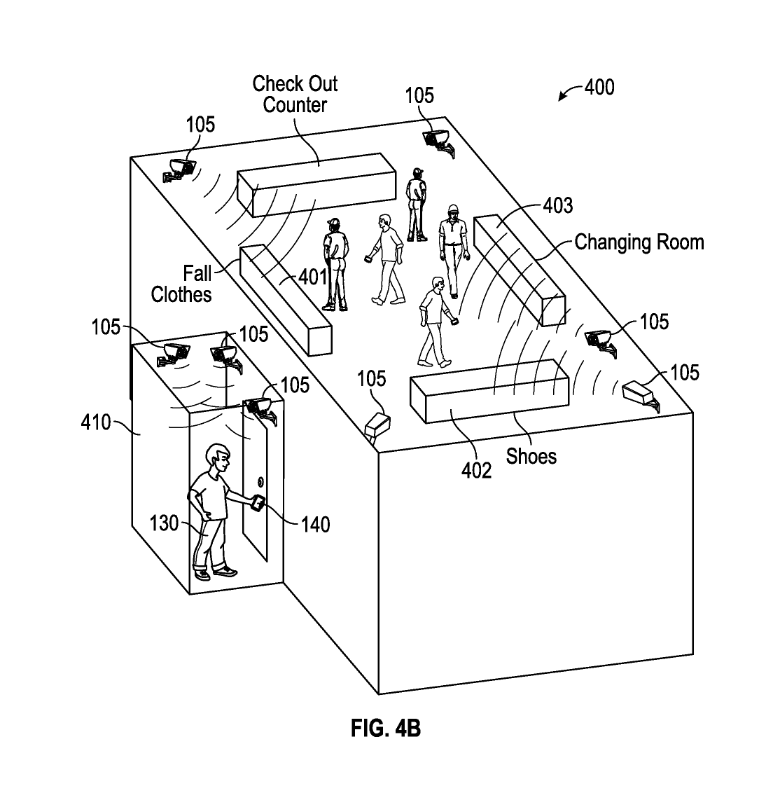

Referring next to FIG. 5, method 500 of implementing a biometric purchasing system, such as system 100, is shown according to one embodiment. Method 500 may be implemented using any combination of computer hardware and software. According to one configuration, method 500 may be implemented as a computer program (e.g., machine-readable instructions) on input/output device 140 of customer 130, or be a web-based application accessible by various user devices.

Method 500 begins by reception of image data regarding a customer (501). According to one embodiment, method 500 can be initiated by, for example, processing circuit 120 receiving one or more inputs from input/output device 140. For example, processing circuit 120 may receive a user input, such as a user may press an “activate” button to begin method 500. According to one embodiment, processing circuit 120 receives image data from one or more image capture devices 105. After reception, body data is generated by processing circuit 120 (502). The body data may include data relating to a user as mentioned above (e.g., biometric data, preference data, safety/protective data, activity data, and/or health/medical data). As such, the user may (e.g., via input/output device) edit and change the characteristics of their body data (e.g., they are six feet tall rather than five feet tall). In some embodiments, a virtual model of the customer is also generated by processing circuit 120 (502). According to one embodiment, processing circuit 120 generates a virtual model of the user (502) that can depict motion and be edited by the user. After generation of one or both of a model and body data, a user-input is received by processing circuit 120 (503). A user-input (503) may include a validation (i.e., accuracy confirmation) of or an edit to all or some aspect(s) of their body data (i.e., biometric data, activity data, safety/protective data, activity data, preference data, and/or health-related data) including model 141; a system control feature; or a purchase option 150 response. Based on the user-input and the body data, one or more purchase options is selectively provided by processing circuit 120 (504).

During generation of body data (502) and/or accuracy input (503), processing circuit 120 may determine one or more inaccuracies in the body data. As mentioned above, the inaccuracies may be determined based on predefined standards (e.g., stored in memory 102), the record of the customer, comparison to additional body data, various matching processes, and/or inputs received from the customer (503). Processing circuit 120 may determine that one or more aspects of the body data (biometric data, safety/protective data, activity data, preference data, and/or health-related data) is inaccurate and selectively provide purchase options only where accurate body data exists. For example, if potentially inaccurate body data exists in regard to a customer's waist size, processing circuit 120 may refrain from providing waist size related purchase options until the accurate waist size is confirmed or inputted.

As mentioned above, the purchase options may include clothing related purchase options; fashion/style related purchase options; location purchase options; and health-related purchase options. For example, a clothing related purchase option may include: “would you like to try cashmere beige sweater from Store A because it would match your brown Store A pants?” According to an alternate embodiment, one or more purchase options are provided (504) without any user-input. Method 500 can be run continuously or selectively activated and deactivated. For example, when method 500 is implemented as an application on input/output device 140, user 130 may press an “end” button to deactivate method 500.

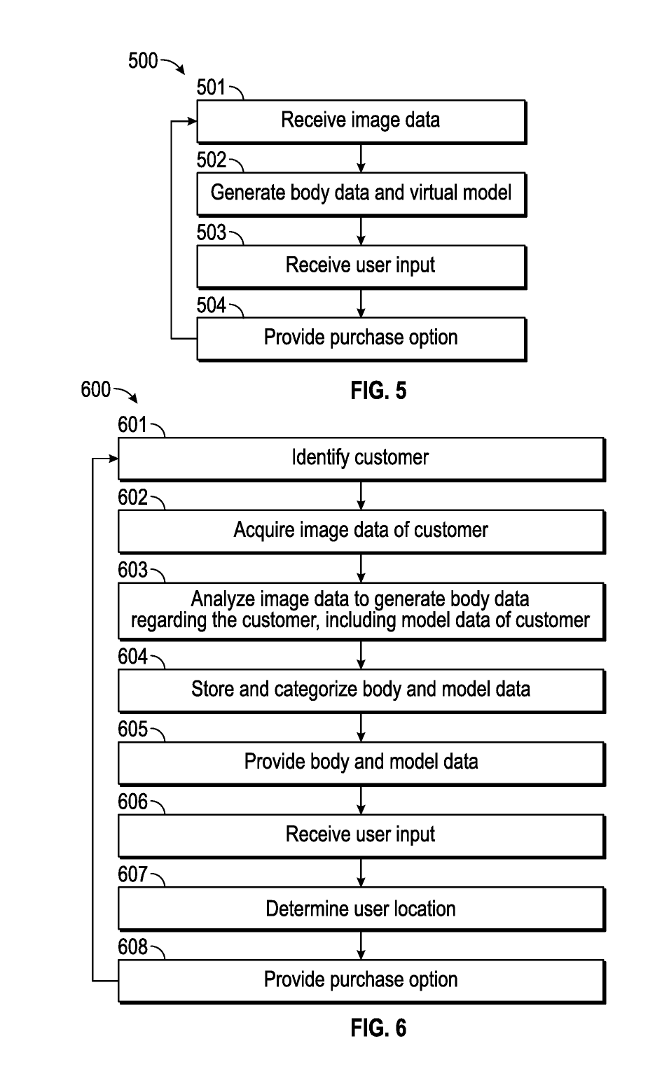

Referring next to FIG. 6, method 600 for providing a purchase option to a customer (i.e., user) is shown according to one embodiment. According to one embodiment, method 600 can be a computer-implemented utilizing system 100. According to another embodiment, method 600 may be implemented using a computer-readable storage medium having machine-readable instructions stored therein. Method 600 is initiated with the customer being identified (601). Identification may be based on customer-initiated conduct (i.e., input of process 606) and/or acquiring image data of the customer (602). For example, the user may activate an application on their input/output device which is received by processing circuit 120. The application may correspond with a specific input/output device and/or Internet Protocol address, such that the user can be identified. Alternatively, facial features or some other identifying characteristic (e.g., fingerprint) may be used to identify the customer based on the acquired image data (e.g., using a facial recognition program or similar application). In another embodiment, identification may be via a comparison of body data and/or virtual models. After identification, a customer's record (e.g., past purchases, preferences, and other body data) may be retrieved, for example, from memory 102. Based on the image data, body data is generated (603). In some embodiments, model data is also generated, for example, by processing circuit 120 (603). The body data typically includes biometric data, activity data, safety/protective data, preference data, and medical/health-related data, like mentioned above. The body and model data may be stored and categorized (604). According to one embodiment, the body and model data are stored in memory 102. The body and model data may be categorized by, for example, type (e.g., biometric data, preference data, activity data, safety/protective data, and health/medical related data). In addition to this initial categorization, the body data may further be categorized (e.g., based on clothing size, season, time of day, event (e.g., Christmas), mood, fit, etc.). In some embodiments, the location of the user may be determined (607), for example, by processing circuit 120. As mentioned above, processing circuit 120 may determine location of the user based on which image capture device acquires image data of the user, an input from the user, a global positioning system (or other location determining system) within input/output device 140 of user, etc. Accordingly, processing circuit 120 may selectively provide a purchase option (608) that is based on the categorically stored body data and location of the user. For example, if over the past three years, the user has only worn Brand A jackets from November to March, and if it is December, one purchase option could include a new Brand A jacket, which reflects the user's past shopping history. In another example, if method 600 is implemented using system 100 in store 400, if the user is at location 401, processing circuit 120 may provide a purchase option regarding fall clothes of, for example, the brand that the user has purchased in the past.

Thus, in addition to selectively providing purchase options based on potential inaccuracies or accuracies in the body data, processing circuit 120 may selectively provide purchase options (608) based on location of the user (e.g., within Store A, online shopping at the user's home, etc.), time of year (e.g., winter or summer), and/or the record of the user including any inputted preferences and/or adjustments to the body data (i.e., categorized and stored image and body data (604)). For example, in regard to selectively providing purchase options based on the time of year, during cold winter months, processing circuit 120 may exclude summer clothes from purchase options provided. However, the selectivity of purchase options provided by processing circuit 120 may be adjusted by the user via one or more inputs (606). For example, the user may input a desire to receive purchase options regarding winter clothes in addition to summer clothes during the warm summer months.

In one embodiment, the body data and model data regarding the customer is provided to the customer (605), for example, by way of an input/output device. As mentioned above, in some embodiments, the model may depict movement, such that the customer can see how he/she would look in a particular piece of, for example, clothing. In some embodiments, a user-input may also be received by (606) for example, by processing circuit 120. The user-input can include an adjustment to and/or accuracy confirmation of all or some aspects of their body data (i.e., biometric data, activity data, safety/protective data, preference data, and/or health-related data) including model 141; a user preferred view; a system control feature input; or a purchase option 150 response. In some embodiments, certain steps of method 600 may be omitted.

According to one example regarding the implementation of method 600 with system 100, as a user enters a store, security cameras obtain either moving or still photographs of the user. The images are transmitted to a processing circuit. The processing circuit analyzes the images to generate body data. In turn, a virtual model of the user can be generated by the processing circuit based on the body data. If the body data is incomplete such that the model is not accurate enough to determine, for example, a shirt size, the processing circuit can instruct the cameras to acquire more images of the user. At or near the same time, the processing circuit can transmit a signal to, for example, the smartphone of the user asking them to activate the system. As mentioned above, the user can activate the system fully (and receive purchase options), or only allow their images to be captured (not receive purchase options), or reject activation of the system entirely. If the user chooses to activate the system fully, the processing circuit will transmit purchase options to, for example, the smartphone of the user. In one embodiment, the user can apply the purchase options to their virtual model, which is also provided by the processing circuit. Accordingly, the model can update to reflect, for example, a pair of pants suggested by the processing circuit. Moreover, because the purchase option provided by the processing circuit is configured to match or substantially match the preferences and characteristics of the user (e.g., their sizes and shape), the model can relatively accurately depict how the user would look with the provided purchase option. In another embodiment, as the user walks through the store, the processing circuit provides purchase options to them based on their location. For example, if the user is in the shoe department of the store, shoe-related purchase options will be provided to them (in their size based on the body data). Furthermore, the user can choose how often they receive purchase options and when to activate/deactivate the system via their smartphone. Thus, by providing purchase options customized to the user (e.g., their sizes and preferences) and showing how those purchase options would look on the user, the user can be better informed of products and services that best fit their desires and characteristics. Although the above example was directed to product-related purchase options, the purchase options could include service-related purchase options as well. For example, the processing circuit could provide the user with a style suggestion consisting of a new haircut, hair color, and make-up color. If the user likes how the style looks on the user's model, the processing circuit can provide them with a location (e.g., a salon) where they can obtain that style.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, a data processing agent. Alternatively or in addition, the program instructions can be encoded on an artificially-generated propagated signal, e.g., a machine-generated electrical, optical, or electromagnetic signal, that is generated to encode information for transmission to a suitable receiver agent for execution by a data processing agent. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing agent on data stored on one or more computer-readable storage devices or received from other sources.

The term “server” includes all kinds of agent, devices, and machines for processing data, including by way of example a programmable processor, a computer, a system on a chip, or multiple ones, or combinations, of the foregoing. The agent can include special purpose logic circuitry, e.g., an FPGA (field programmable gate array) or an ASIC (application-specific integrated circuit). The agent can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The agent and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and the agent can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A purchasing system, comprising:
a memory device configured to receive and store image data regarding a user, wherein the image data is acquired by an image capture device without input from the user; and
a processing circuit coupled to the memory device and configured to:
generate body data of the user based on the image data, the body data including a virtual model of the user, the virtual model providing a depiction of the user based on the body data;
generate a customized purchase option for the user based on the body data; and
selectively provide the purchase option to an input/output device based on the body data.

2. The system of claim 1, wherein the selectively provided purchase option is based on a determination by the processing circuit of an identity of the user based on the body data.

3.-5. (canceled)

6. The system of claim 1, wherein the selectively provided purchase option is based on a determination by the processing circuit regarding an accuracy of the body data.

7. (canceled)

8. The system of claim 6, wherein the processing circuit is configured to re-determine the accuracy of the body data based on additional image data.

9. The system of claim 6, wherein the processing circuit is configured to predict an ability of an additional image to improve the accuracy of the body data.

10.-16. (canceled)

17. The system of claim 1, wherein the image data is based on a first image and a second image, wherein the second image is at least one of acquired at a different time than the first image and acquired at a different location than the first image.

18. (canceled)

19. The system of claim 1, wherein the body data includes biometric data, the biometric data including an indication of at least one of a height, a gender, a weight, a body-shape, an arm length, a leg length, a hand size, a neck size, a foot size, a head diameter, a chest size, a ring finger size, a skin color, an eye color, a hair length, and a hair color.

20. The system of claim 1, wherein the body data includes biometric data, the biometric data further including an indication of at least one of a waist size, a hip size, a pants length, a collar size, a shirt size, a jacket size, a shoe size, a belt size, a glove size, and a brassiere size.

21. (canceled)

22. The system of claim 1, wherein the body data includes biometric data, the biometric data including an indication of one or more facial features.

23.-24. (canceled)

25. The system of claim 1, wherein the body data includes health/medical data, the health/medical data including an indication of at least one of a body-mass-index, a posture characteristic, a walking gait characteristic, and a skin characteristic.

26. (canceled)

27. The system of claim 1, wherein the body data includes safety/protective data, the safety/protective data including an indication of a use of safety equipment including at least one of a size and type of a safety helmet, a knee pad, an elbow pad, a safety harness, a protective apron, a safety glove, a life jacket, and an overall.

28. The system of claim 1, wherein the body data includes activity data, the activity data including an indication of activity equipment use including at least one of a size of a bicycle frame, a racquet, a golf club, a ski suit, a ski, and a snowboard.

29. The system of claim 1, wherein the processing circuit is configured to selectively provide the customized purchase option based on at least one of health/medical data, safety/protective data, and activity data regarding the user.

30. The system of claim 1, wherein the body data includes preference data for the user, wherein the processing circuit is configured to generate and selectively provide the customized purchase option based on the preference data for the user.

31.-35. (canceled)

36. The system of claim 1, wherein the processing circuit is configured to modify the model based on at least one of a clothing related purchase option and a fashion/style related purchase option.

37.-44. (canceled)

45. A purchasing system, comprising:
an image capture device configured to acquire image data of a clothed user and transmit the image data to a processing circuit, wherein the image data is acquired by the image capture device without input from the user;
a memory device configured to store the image data regarding the user; and
a processing circuit coupled to the memory device and the image capture device and configured to:
generate body data of the user based on the image data, the body data including a virtual model of the user;
generate a customized purchase option for the user based on the body data; and
selectively provide the purchase option based on the body data.

46.-56. (canceled)

57. The system of claim 45, wherein the virtual model is configured to depict a movement of the user.

58. The system of claim 45, wherein the processing circuit is configured to transmit a user selected visual representation of the virtual model to an input/output device of the user.

59. The system of claim 45, wherein the processing circuit is configured to modify the model based on at least one of a clothing related purchase option and a fashion/style related purchase option.

60. The system of claim 45, wherein the processing circuit is configured to receive an input from the user including at least one of an adjustment to the body data, a user preferred view, a system control feature input, and a response to the purchase option.

61. The system of claim 60, wherein the user preferred view includes at least one of a more accurate and a less accurate virtual model of the user.

62. The system of claim 60, wherein the user preferred view includes allowing the processing circuit to suggest body models based on an effect of a cosmetic procedure, wherein the effect is based on at least one of a rhinoplasty, a facial procedure, a breast reduction, a breast augmentation, and a liposuction.

63. (canceled)

64. The system of claim 60, wherein the adjustment to the body data includes additional image data.

65. The system of claim 64, wherein the processing circuit is configured to augment the image data with the additional image data from one or more social media profiles of the user.

66. (canceled)

67. The system of claim 60, wherein the system control feature input enables the memory device to store the data anonymously.

68. (canceled)

69. The system of claim 60, wherein the purchase option response includes at least one of a rejection of the purchase option and a request for an alternative purchase options.

70. The system of claim 60, wherein the purchase option response includes a selection to locate the purchase option, wherein the processing circuit is configured to provide a webpage link to the purchase option.

71.-76. (canceled)

77. The system of claim 45, wherein the image capture device includes a commander, wherein the processing circuit is configured to direct the commander to provide an instruction to the user, the instruction including at least one of a direction to the user to move into view of the image capture device, and a direction to the user to rotate one or more of their extremities in view of the image capture device.

78.-80. (canceled)

81. A purchasing system, comprising:
an image capture device configured to acquire image data of a fully-clothed user and transmit the image data to a processing circuit;
a memory device configured to store the image data regarding the user;
a body image enhancer configured to apply a force to the user to acquire relatively greater detailed image data; and
a processing circuit coupled to the memory device, the body image enhancer, and the image capture device, wherein the processing circuit is configured to:
control the body image enhancer;
generate body data of the user based on the image data;
generate a customized purchase option for the user based on the body data; and
selectively provide the purchase option based on the body data.

82. The system of claim 81, wherein the selectively provided purchase option is based on a determination by the processing circuit regarding an accuracy of the body data.

83. The system of claim 82, wherein the processing circuit is configured to provide the purchase option only for determined accurate body data aspects.

84. The system of claim 82, wherein the determination is based on at least one of a predefined accuracy standard, a comparison to a record of the customer, a comparison to additional generated body data of the user, and a user input.

85. The system of claim 84, wherein the user input received by the processing circuit includes at least one of an accuracy and inaccuracy confirmation of the body data.

86. (canceled)

87. The system of claim 81, wherein the body image enhancer includes an air mover configured to apply an air stream against the user, such that the user's clothes are pressed against the user's body.

88. The system of claim 81, wherein the body image enhancer includes a presser configured to press the user's clothes against the user's body.

89.-183. (canceled)
